(19) United States
(12) Patent Application Publication
(10) Pub. No.: US 2011/0303034 A1
(43) Pub. Date: Dec. 15, 2011

(54) ECCENTRIC PUSH MEMBER DEVICE FOR MOTOR VEHICLE RACK-AND-PINION STEERING ASSEMBLY

(75) Inventors: Nicolas Plataret, Lyon (FR); Patrice Brochot, Oullins (FR); Dominique Couchoux, Thurins (FR)

(73) Assignee: JTEKT EUROPE, IRIGNY (FR)

(21) Appl. No.: 13/055,673

(22) PCT Filed: Jul. 9, 2009
(86) PCT No.: PCT/FR2009/051364

§ 371 Date: Aug. 24, 2011

(30) Foreign Application Priority Data
Jul. 23, 2008 (FR) 08/04191

(51) Int. Cl. F16H 55/28

(52) U.S. Cl. 74/409

(57) ABSTRACT

The push member device (1) of the present invention includes a rotatable mounting (4), the inner circumference (5) of which is eccentric relative to the outer circumference (6). The mounting (4) is rotationally biased in a direction by a spring (10) and is placed against the back of the rack (2) that is thus pushed against the teeth of the steering pinion. The rotatable mounting (4) is rotatably mounted in a housing (7), itself being slidably mounted in the steering gearbox. A shock absorbing spring means (11) is arranged between the sliding housing (7) and the steering gearbox to absorb the alignment defects of the rack (2).

### TECHNICAL FIELD

The present invention generally relates to steering systems of motor vehicles. More particularly, the invention provides a push member device for a motor vehicle rack-and-pinion steering assembly. Still more particularly, this is a so-called <<eccentric>> push member device.

### BACKGROUND

It is recalled that in most present steering systems of motor vehicles, a steering pinion is linked in rotation with a steering column, maneuvered by means of the steering wheel of the vehicle, the pinion being engaged with a rack which is slideably mounted in the longitudinal direction in a steering gearbox. Both ends of the rack, outside the gearbox, are respectively coupled with two steering connecting rods, which are then themselves respectively associated with the left and right steered wheels of the vehicle. Thus, rotation of the steering wheel in one direction or in the other, transmitted by the steering column to the pinion, is converted into a corresponding translation of the rack which, via connecting rods, causes orientation of the steered wheels for steering right or left.

In such a steering system, the rack-and-pinion mechanism, linked to the front running gear of the vehicle via connecting rods, is subject to load transfers, to impacts and vibrations, depending on the condition of the road covered by the vehicle. Because of the angle formed by the connecting rods with the rack, a load may then occur on the rack which risks moving it away from the pinion. For this reason, the rack is customarily applied permanently against the pinion by a so-called “push member” device elastically acting on the back of the rack in the region of the pinion in order to strongly press the gear teeth of this rack against the pinion. Thus the push member limits the play between the respective teeth of the pinion and of the rack, and this push member also allows control of the sliding force of the rack in the gearbox. Further the action of the push member allows compensation of the alignment defects of the rack.

In its most current embodiment, the pusher member device comprises the pusher member strictly speaking, which is a rigid part mounted so as to be translationally mobile in a direction substantially perpendicular to the longitudinal axis of the rack, and urged towards the back of the rack by spring means also positioned along a direction substantially perpendicular to the longitudinal axis of the rack.

On the contrary, in the case of an eccentric push member device as described for example in U.S. Pat. No. 6,247,375 B1 (or patent documents FR 2219868 A and EP 0770538 A2), a rotary mounting comprising an off-center portion which pushes the rack towards the pinion, the rotary mounting being rotatably mounted in a housing, such as the housing of a pinion, around an axis parallel to the longitudinal axis of the rack. The inner circumference of said mounting is off-center with respect to its outer circumference, so that when it rotates in the housing, its off-center portion is applied against the back of the rack and pushes the latter towards the teeth of the pinion, so as to keep them engaged. The mounting is rotationally biased in one direction by a spring (in particular see aforementioned document FR 2 219 868A), so as to make up for the play caused by the inaccuracies of the mounting and by the wear between the teeth of the rack and the teeth of the pinion.

In the case of the aforementioned U.S. Pat. No. 6,247,375 B1, the inner portion of the rotary mounting includes a recess in which is mounted a leaf spring, which will bear upon the rack and thereby allow a slight radial movement in order to compensate for the alignment defects of the rack.

The advantages of a resident eccentric push member device, in particular, lie in the compactness of such a device, and in the fact that it may be made irreversible, any backward return of the rotary mounting (from a certain angular position reached) being made impossible.

However, in the arrangement according to US Pat. No. 6,247,375 B1, the fact of placing the leaf spring between the rotary mounting and the rack has the consequence that, when the rack is urged by variable forces, the latter does not always bear upon the spring in the same way, which may cause losses of contact between said spring and the rack. Further, the leaf spring changes position over time, considering the gradual rotation of the mounting, which causes a change in the orientation and in the intensity of the forces applied on the rack. All this may strongly degrade the function fulfilled by the eccentric push member device.

### BRIEF SUMMARY

The present invention aims at finding a remedy to these drawbacks, therefore at improving the operation of an eccentric push member device for a rack-and-pinion steering system, by better control over the movements and positions of the members of the push member device.

For this purpose, the invention comprises an eccentric push member device for a rack-and-pinion steering assembly of a motor vehicle, a device which comprises in a known way per se, a rotary mounting, the inner circumference of which is off-center relatively to the outer circumference, said support being rotationally biased in one direction by spring means, and being provided so as to be applied by its off-center inner circumference against the back of the rack in order to push the latter back towards the teeth of the steering assembly pinion, this eccentric push member device being essentially characterized by the fact that the rotary mounting is rotatably mounted in a housing, itself slideably mounted substantially perpendicularly to the plane of the teeth of the rack, other damping spring means being positioned between the sliding housing and a fixed member, such as the steering gearbox, in order to act on said housing along its sliding direction.

Thus the principle of the invention comprises separating the function of making up for the plays due to the assembling and to wear, which is achieved by the eccentric mounting itself, on the one hand, and the function of absorbing alignment defects of the rack and optionally geometrical defects of the pinion, which is achieved by the translational movement of the housing, subject to the action of damping spring means themselves bearing upon the housing, on the other hand. This association of both functions in particular gives the possibility of having proper guiding of the rack which directly rests on a rigid support with an off-center portion. It also allows limitation of the degradation causes of irreversibility of the push member device, by stabilizing the supports of the rotary mounting. The absorption of the alignment defects of the rack is better controlled because of the guiding of the sliding housing in a slide made in the steering gearbox.

The spring means, which urge into rotation the mounting with an off-center portion, are here positioned between this rotary mounting and the sliding housing; these means may be formed by at least one compression or traction spring, or by at least one torsion spring, or by at least one leaf spring or further by at least one coil spring.

The damping spring means, placed between the sliding housing and the steering gearbox, may be formed by at least one leaf spring or by at least one block in elastomer, or by at least one O-ring gasket, or by at least one compression spring.

In a particular embodiment, these damping spring means comprise two O-ring gaskets, respectively placed at both ends of the sliding housing, around this housing.

### BRIEF DESCRIPTION OF THE FIGURES

The invention will be better understood with the description which follows, with reference to the appended schematic drawing illustrating as an example an embodiment of this eccentric push member device for a motor vehicle rack-and-pinion steering assembly.

FIG. 1 is a block diagram of an eccentric push member device according to the present invention;

FIG. 2 is a diagram illustrating the irreversibility condition of the push member device;

FIG. 3 is another explanatory diagram, illustrating an aspect of the operation of this push member device;

FIG. 4 is a sectional view passing through the axis of the rack, of a practical exemplary embodiment of the eccentric push member device according to the invention;

FIG. 5 is a cross sectional view of this push member device, along V-V of FIG. 4, more particularly showing the making of the slide for translationally guiding the sliding housing.

### DETAILED DESCRIPTION

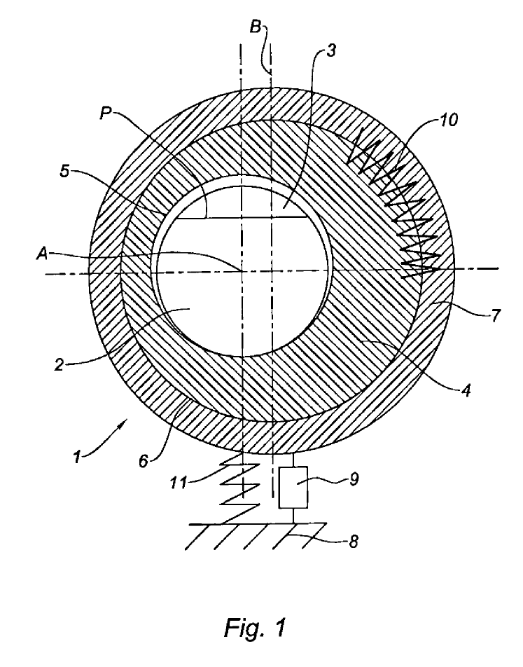

First with reference to FIG. 1, the push member device designated as a whole by the mark 1 is associated with a rack 2 of a motor vehicle steering assembly. The rack 2, the longitudinal axis of which is indicated by A, has teeth 3, the plane of which is indicated in P. The push member device 1 is placed at a small distance from the steering pinion (not shown here) which will engage with the teeth 3 of the rack 2.

The push member device 1 comprises, as a main component, an eccentric mounting 4 which is a rigid part with a general annular conformation, but including a circular inner circumference 5 which is off-center relatively to its circular outer circumference 6. The eccentric mounting 4 is crossed by the rack 2, its circular inner circumference 5 is applied against the back of the rack 2 i.e. against the outer region of this rack 2 opposite to the teeth 3 of the latter.

The eccentric mounting 4 is rotatably mounted in a housing 7 of corresponding shape, in other words a housing with a general cylindrical aspect, which is itself guided in translation in the direction of an axis B, orthogonal to the plane P of the teeth 3 of the rack 2. The guiding in translation of the housing 7 is ensured by a connection of the “slide” type with the steering gearbox, a gearbox which is symbolized in 8 as a fixed portion, the connection of the slide type being itself schematized in 9.

A first elastic element 10 mounted between the eccentric mounting 4 and the sliding housing 7, urges this eccentric mounting 4 into rotation in a given direction. A second elastic element 11, with damping properties, is mounted between the sliding housing 7 and the steering gearbox 8 and acts parallel to the connection of the slide type 9.

The rotary eccentric mounting 4, with which is associated the elastic element 10, is dimensioned so that it is irreversible and driven into rotation by sliding by means of the elastic element 10, in order to press on the back of the rack 2, while compensating for the assembling and wear plays, the average angular position of the eccentric mounting 4 is suitably selected in order to compensate for a maximum of wear along the axis B defined earlier, while minimizing the movement of the rack 2 along the axis C perpendicular to this axis B and located in a plane normal to the longitudinal axis A of the rack 2, in other words the plane of FIG. 1. The second elastic element 11, which is a damping element, allows controlled relative displacement of the teeth of the steering pinion and of the teeth 3 of the rack 2, in order to absorb the alignment defects of this rack 2, it being understood that the rated force, the stiffness and the damping of the second elastic element 11 are selected for obtaining such a controlled relative displacement.

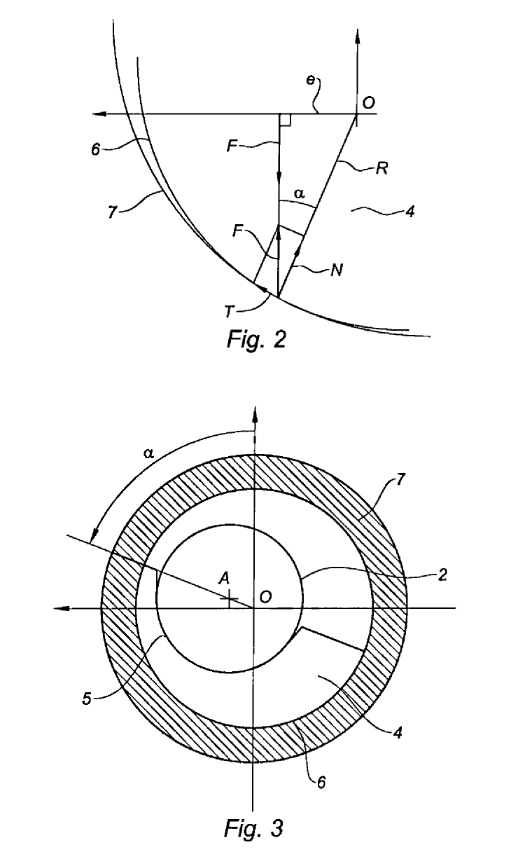

As regards the rotary eccentric mounting 4, the expression “dimensioned so that it is irreversible” means that the different dimensions observe the following condition (see FIGS. 2 and 3):

The ratio between the value of the eccentricity e and the radial distance between the center O of the outer circumference 6 of the eccentric mounting 4 and the point of contact between the eccentric mounting 4 and the sliding housing 7 is less than the value of the static friction co-efficient between the eccentric mounting 4 and the sliding housing 7 for low eccentricity values.

In the previous formulation, “by value of the eccentricity” is meant the minimum distance between the longitudinal axis of the inner circumference 5 and the longitudinal axis of the outer circumference 6 of the eccentric mounting 4.

This irreversibility condition may be written generally as:

e/R.cos(α))<f

i.e. for an angle α for which the value is close to zero:

e/R<f

formula in which:

e is the value of the eccentricity,

R is the contact radius, in other words the distance between the center O of the outer circumference 6 of the eccentric mounting 4 and the point of contact,

f is the static friction co-efficient between both surfaces in contact.

The formulation according to which << the average angular position of the eccentric mounting is suitably selected in order to compensate a maximum of wear along the axis B defined earlier, while minimizing the movement of the rack 2 along the axis C perpendicular to this axis B and located in a plane normal to the longitudinal axis A of the rack 2 >> is explained by the diagram of FIG. 3. It means that the angle α, formed by the straight line passing through the center of the off-center inner circumference 5 and through the center O of the outer circumference 6 of the eccentric mounting 4, on the one hand and through the straight line normal to the plane P of the teeth 3 of the rack 2, on the other hand, is an angle for which the value should vary in a reduced interval and be centered on an average value equal to 90°.

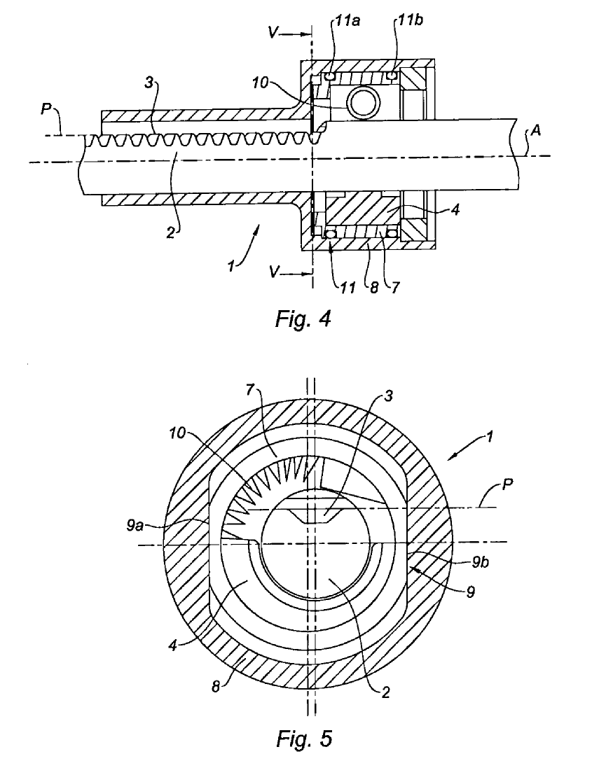

Now referring to FIGS. 4 and 5, a practical embodiment of the push member device 1 will be described herein below, corresponding to the principles discussed earlier.

The eccentric mounting 4 here has a corner shape, and is rotationally biassed by a compression spring 10 which follows a curved path as a circular arc, inside the housing 7 which itself has a general cylindrical aspect. The whole is mounted inside a steering gearbox portion 8, surrounding the rack 2 and located in proximity to the steering pinion (not shown). As shown by FIG. 5, the slide connection 9 between the housing 7 and the gearbox 8 is achieved with flats 9a and 9b parallel to each other and perpendicular to the plane P of the teeth 3 of the rack 2.

Again referring to FIG. 4, the elastic member 11 having damping properties here comprises two O-ring gaskets 11a and 11b, which are mounted in annular grooves respectively made towards both ends of the housing 7. Positioned in this way, both O-ring gaskets 11a and 11b allow the sliding of the housing 7 in the direction of the link of the slide type 9, while damping this sliding.

One would not depart from the scope of the invention, as defined in the appended claims:

by changing shape details of the components of the device, such as the eccentric mounting and the sliding housing,

by resorting to any equivalents of the described means, notably by replacing the compression spring, acting on the eccentric mounting, with a spring of another type, such as a traction spring or a torsion spring, or a leaf spring or a coil spring,

also, by replacing the double O-ring gasket with any other elastic element having damping properties, such as a spring leaf in a suitable material, or a block in elastomer, or a compression spring,

by dedicating this push member device to steering systems of any types, which may be manual steering assemblies or electric or hydraulic assisted steering assemblies.

1. An eccentric push member device for a rack-and-pinion of a motor vehicle, the push member device comprising a rotary mounting, an inner circumference of which is eccentric relative to an outer circumference, said mounting being rotationally biased in a direction by spring means, and being provided so as to be applied through an off-center inner circumference against back of the rack so as to push the latter back towards teeth of the steering pinion, wherein the rotary mounting is rotatably mounted in a housing, the rotary mounting being slideably mounted substantially perpendicularly to a plane of the teeth of the rack, other damping spring means being positioned between the sliding housing and a fixed member comprising the steering gearbox to act on the sliding housing along a sliding direction.

2. The eccentric push member device according to claim 2, wherein the housing is slideably guided in a slide made in the steering gearbox.

3. The eccentric push member device according to claim 1, wherein the spring means which rotationally bias the mounting with an off-center portion, are positioned between the rotary mounting and the sliding housing, and are at least formed with a compression or traction spring.

4. The eccentric push member device according to claim 1, wherein the spring means which rotationally bias the mounting with an off-center portion, are positioned between the rotary mounting and the sliding housing and are formed with at least one torsion spring.

5. The eccentric push member device according to claim 1, wherein the spring means which rotationally bias the mounting with an off-center portion, are positioned between the rotary mounting and the sliding housing, and are formed with at least one leaf spring.

6. The eccentric push member device according to claim 1, wherein the spring means which rotationally bias the support with an off-center portion, are positioned between the rotary mounting position and the sliding housing, and are formed by at least one coil spring.

7. The eccentric push member device according to claim 1, wherein the damping spring means, placed between the sliding housing and the steering gearbox are formed with at least one spring leaf.

8. The eccentric push member device according to claim 1, wherein the damping spring means, placed between the sliding housing and the steering gearbox are formed with at least one block in elastomer.

9. The eccentric push member device according to claim 1, wherein the damping spring means placed between the sliding housing and the steering gearbox are formed with at least one O-ring gasket.

10. The eccentric push member device according to claim 9, wherein the damping spring means comprise two O-ring gaskets respectively placed at both ends of the sliding housing, around the sliding housing.

11. The eccentric push member device according to claims 1, wherein the damping spring means placed between the sliding housing and the steering gearbox are formed with at least one compression spring.
